(19) United States
(12) Patent Application Publication
(10) Pub. No.: US 2002/0093512 A1
(43) Pub. Date: Jul. 18, 2002

(54) Programmable interface

(75) Inventor: Wen Nan Tseng, Kaohsiung (TW)

Correspondence Address: LOWE HAUPTMAN GILMAN & BERNER, LLP, Suite 310, 1700 Diagonal Road, Alexandria, VA, 22314, US

(73) Assignee: HANNSTAR DISPLAY CORP.

(21) Appl. No.: 09/953,563

(22) Filed: Sep. 17, 2001

(30) Foreign Application Priority Data
Jan. 15, 2001 (TW) 90100993

(51) Int. Cl. G09G 5/00

(52) U.S. Cl. 345/619

(57) ABSTRACT

A programmable interface is disclosed for connecting a signal source having a plurality of output pins with an electronic apparatus having a plurality of input pins. The programmable interface comprises a complex programmable logic device (CPLD) for mapping the input pins of the electronic apparatus with the corresponding output pins of the signal source as the definition is different between the input pins of the electronic apparatus and the output pins of the signal source.

### BACKGROUND OF THE INVENTION

1. Field of the Invention

The present invention generally relates to a programmable interface, and more particularly to a programmable interface used for transferring the display signal to the liquid crystal display (LCD) module.

2. Description of the Related Art

Due to the advance of electronic technology, especially for the popularity of portable electronic products, the requirements of light, compact and low-energy consuming display are gradually increasing. With the advantages of low-energy consuming, low-heat dissipation, light weight and non-luminescence display, liquid crystal displays (LCD) have been widely used in the electronic products and even have replaced the traditional CRT displays.

The manufacturing process of LCD substantially includes the steps of injecting the liquid crystal material into the space between two flat glasses with glass electrodes thereon, and attaching polarizing films onto the outer surfaces of the flat glasses so as to form the LCD cell. Then, driving circuits, controlling circuit, backlight components and a frame will be assembled to constitute an LCD module.

After accomplishing the LCD module, the controlling signals of red (R),green (G),blue (B) and clock have to be delivered to the LCD module to proceed the testing and aging process. Generally, the apparatus having the LCD, especially for color LCD with large dimension, usually generates digital signals that are encoded and delivered to a connector through a signal transmitter such as low voltage differential signal transmitter (LVDS), and Transistor-Transistor logic transmitter (TTL). The connector connects with a corresponding connector of the LCD module which has a signal receiver used for decoding the received signal and then displaying the signal.

However, the LCD modules manufactured by different manufacturers usually have different definition of the I/O pins of the LVDS transmitter. Therefore, for original equipment manufacturing (OEM) manufacturers, there is a need to provide various corresponding circuit boards used for conforming the definition of signal I/O pins of LCD modules from different manufacturers.

Moreover, the display signals are not directly transferred to the LCD module for the present products having LCD modules. The display signals need another encoding process for transforming into common display signals prior to being transferred to the LCD module. However, the encoding process not only increases the product cost but also has possibility to make the signal error.

Accordingly, there exist the needs for providing a programmable interface, wherein the programmable interface can change the definition of the pins such that when the definition of the input pin of the apparatus is different, the signal can be easily transferred to the apparatus through the programmable interface.

### SUMMARY OF THE INVENTION

It is a primary object of the present invention to provide a programmable interface, wherein the programmable interface can change the definition of the output pins such that when the definition of the input pins of the apparatus is different, the signal can be easily transferred to the apparatus through the programmable interface.

It is another object of the present invention to provide a programmable interface to be applied to a product, wherein the signal mapping among the elements of the product can be more conveniently achieved.

In order to achieve the above objects, the present invention provides a programmable interface for connecting a signal source having a plurality of output pins with an electronic apparatus having a plurality of input pins, wherein the programmable interface comprises a complex programmable logic device (CPLD) for mapping the input pins of the electronic apparatus with the corresponding output pins of the signal source as the definition is different between the input pins of the electronic apparatus and the output pins of the signal source.

According to one aspect of the programmable interface of the present invention, wherein the electronic apparatus is an LCD module.

According to another aspect of the present invention, the programmable interface further comprises an encoding device and an output connector, and the electronic apparatus has a corresponding decoding device and a corresponding input connector.

According to the programmable interface of the present invention, when the signal source is connected to different electronic apparatus, the input pins of the electronic apparatus can be easily mapped with the corresponding output pins of the signal source as the definition is different between the input pins of the electronic apparatus and the output pins of the signal source.

Other objects, advantages, and novel features of the invention will become more apparent from the following detailed description when taken in conjunction with the accompanying drawing.

### BRIEF DESCRIPTION OF THE DRAWINGS

FIG. 1 is a diagram of the programmable interface according the embodiment of the present invention.

### DESCRIPTION OF THE PREFERRED EMBODIMENT

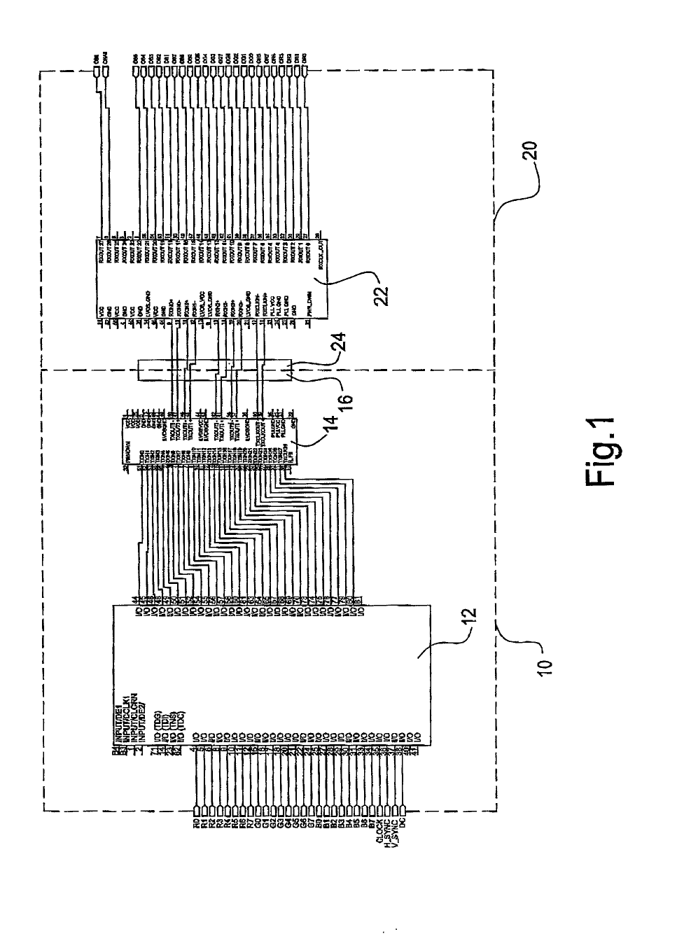

Following text will use the LCD module as the example to illustrate the present invention in detail, but it should be understood that the programmable interface of the present invention is not limited to the LCD module. Referring to FIG. 1, it depicts a diagram of the programmable interface according to the embodiment of the present invention, and the programmable interface is used to transfer the display signal to an LCD module.

The transferring of the signal is substantially separated into two parts, one is the signal output side 10 (as shown in phantom line in the figure) and another is the module side 20 (as shown in phantom line in the figure ). As detecting an LCD module, display signals are needed to be delivered to the LCD module, and the display signals are digital and substantially include signals of red (R), green (G), blue (B) and clock etc. (as labeled by R0-R7, G0-G7, B0-B7 and CLOCK etc.)

The display signal is first delivered to a complex programmable logic device (CPLD) 12, wherein the complex programmable logic device 12 can be EPM128S 84PIN CPLD of MAX7000 sold by Altera Ltd. The complex programmable logic device 12 has thirty I/O pins used to receive the digital display signals, and another thirty I/O pins used to deliver the corresponding digital display signals to a low voltage differential signal transmitter (LVDS) 14 for encoding the corresponding digital display signals. The encoded digital display signals are output to a signal output connector 16.

The signal output connector 16 connects with a module connector 24 for delivering the encoded display signal to a LVDS receiver 22 which decodes the encoded display signal for outputting the corresponding digital display signal so that the display signals are displayed in the display. The output digital display signals correspond to the input digital display signal and substantially include signals of red (R), green (G), blue (B) and clock etc. (as labeled by OR0-OR7, OG0-OG7, OB0-OB7 and CLOCK etc.)

Moreover, it should be appreciated by those skilled in the art that the LCD modules manufactured by different manufacturers usually have different definition of the I/O pins of the LVDS transmitter 22, and even use other signal transfer model such as TTL etc. Therefore, as the definition of the output pins of the module side 20 changes, the complex programmable logic device 12 can change the mapping correspondence of signals between the input signals and LVDS transmitter 14.

Besides, the present invention can also be applied to a product having the LCD. As the manufacturer of the product purchases the LCD modules with different definition of pins from different suppliers, the complex programmable logic device can be employed to deliver the display signal to the LCD module.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A programmable interface for connecting a signal source having a plurality of output pins with an electronic apparatus having a plurality of input pins, the programmable interface comprising:
a complex programmable logic device (CPLD) for mapping the input pins of the electronic apparatus with the corresponding output pins of the signal source as the definition is different between the input pins of the electronic apparatus and the output pins of the signal source.

2. The programmable interface as claimed in claim 1, wherein the electronic apparatus is an LCD module.

3. The programmable interface as claimed in claim 1, wherein the electronic apparatus has a decoding device and an input connector, and the programmable interface has a corresponding encoding device and an output connector, whereby the encoding device can encode the signal from the signal source and the encoded signal is delivered through the output connector to the input connector of the electronic apparatus for decoding the encoded signal.

4. The programmable interface as claimed in claim 3, wherein the encoding device is a low voltage differential signal transmitter (LVDS transmitter) and the decoding device is a low voltage differential signal receiver (LVDS receiver).

5. A method for detecting an electronic apparatus having input pins for receiving signals for operating the electronic apparatus, the method comprising:
providing a signal source having a plurality of output pins for outputting the signal; and
providing a complex programmable logic device for mapping the output pins to the input pins.

6. A method as claimed in claim 5, wherein the electronic apparatus is an LCD module.

7. A method as claimed in claim 5, wherein the electronic apparatus has a decoding device and an input connector, and the method further comprises:
providing a corresponding encoding device and an output connector, whereby the encoding device can encode the signal from the signal source and the encoded signal is delivered through the output connector to the input connector of the electronic apparatus for decoding the encoded signal.

8. A method as claimed in claim 7, wherein the encoding device is a low voltage differential signal transmitter (LVDS transmitter) and the decoding device is a low voltage differential signal receiver (LVDS receiver).

9. A detecting apparatus of the liquid crystal display module having a liquid crystal display device, an input connector and a decoding device with a plurality of pins for delivering signal to the liquid crystal display device, comprising:
a signal source having a plurality of output pins for outputting the signals;
an output connector for connecting with the input connector of the liquid crystal display module;
an encoding device connected with the output connector for encoding the signals and delivering the encoded signals to the output connector, the encoding device having a plurality of signal pins; and
a complex programmable logic device connected with the output connector,
wherein the complex programmable logic device can change the definition of the signals from the output pins for mapping signal pins of the encoding device corresponding to the pins of the decoding device.

10. A detecting apparatus of the liquid crystal display module as claimed in claim 9, wherein the encoding device is a low voltage differential signal transmitter (LVDS transmitter) and the decoding device is a low voltage differential signal receiver (LVDS receiver).
